(19) United States
(12) Patent Application Publication
(10) Pub. No.: US 2013/0057398 A1
(43) Pub. Date: Mar. 7, 2013

(54) Impact-Warning and Prevention Device

(71) Applicant: Man WEN, Walnut, CA (US)

(72) Inventor: Man WEN, Walnut, CA (US)

(21) Appl. No.: 13/226,663

(22) Filed: Sep. 7, 2011

(51) Int. Cl. B60Q 1/26

(52) U.S. Cl. 340/435

(57) ABSTRACT

An impact-warning and prevention device in the shape of a license plate holder is disclosed, where some strong LED lights will be activated to shine focused light at the driver in the aft vehicle, so that the aft driver gets sufficient warning for slowing down or keeping a safer distance, if the aft vehicle is coming too close to the vehicle equipped with device of present application.

### FIELD AND BACKGROUND OF THE INVENTION

The present invention relates generally to an improved design and construction of an impact-warning and prevention device; particularly, it is made into a license plate holder for mounting to the rear portion of a vehicle, so that, when activated, some high-intensity LED light would shine towards the aft-vehicle that is coming too close.

Although there are existing audible alert systems used in various types of motor vehicles to alert pedestrians, bicyclists, etc. that a vehicle is backing up, there is no impact-warning system that is designed to warn or alert the car coming from behind and thus produces an effective warning signal (such as strong lighting) to the driver in the aft vehicle. In the case of cars cruising at higher speed, the driver in the aft vehicle may get dull to the sense of speed (due to the nature of cruising at high speed) and oftentimes does not have sufficient time to slow down and avoid impacting the front vehicle, if the front vehicle starts to slow down while there is no immediate warning to the driver in the aft vehicle.

U.S. Pat. No. 4,851,813 to Gottlieb (“Gottlieb 813”) discloses a combination back-up light and sound-emitting device for an automotive vehicle including a housing having a base at one end and a socket at the other end. A light bulb is mounted in the socket of the housing and a sound-emitting device is also mounted in the housing. Gottlieb 813 does not have the desired “warning to the aft driver”, as discussed herein.

U.S. Pat. No. 6,720,868 issued to Flick taught a back-up warning system that includes a license plate holder, a proximity sensor and external audible indicator. The control circuitry of the system is connected to the vehicle's control system, so that when the reverse gear in the transmission is selected, the warning system is activated. Even though the warning detecting is implemented in a license plate holder, similar to the device of present invention, the is no teaching of any sort to create warning signal to the vehicle driving behind a car equipped with the warning device of present invention.

U.S. Pat. Nos. 4,797,673; 4,864,298; and 5,028,920 (issued to Dombrowski) disclose a driver-alerting device that employed the Doppler radar technology to produce audible signal, when objects coming within range are detected. Connection can be made to the driver's compartment and instrumentation panel to also cause other warning lights to go on.

Dombrowski patents similarly lacked the feature of producing a warning signal light to the driver of the aft vehicle.

On the market, as well as in any prior art patents, there is simply no such warning device that creates an “alert signal” to the driver in the aft vehicle, especially where the visibility is reduced/limited (such as foggy weather) or where there is common dull sense of speed/distance.

The motion-sensing unit used in present application is a known art in the field, which consists of the radio wave transmitting and receiving control circuitry for creating the electronic trigger within the set range. Such technology is available and needs no disclosure or recitation herein and forms no part of the protected invention, except to the extent that it is incorporated and adapted to the implementation herein.

### DESCRIPTION OF THE DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows the assembled view of present invention.

FIG. 2 shows the back side of the license plate holder of present invention.

FIG. 3 shows a mode of operation for the license plate holder of present invention.

FIG. 4 shows the preferred vertical (up-down) angle of the LED lights.

FIG. 5 shows the preferred horizontal fanning angle of the motion sensing detecting.

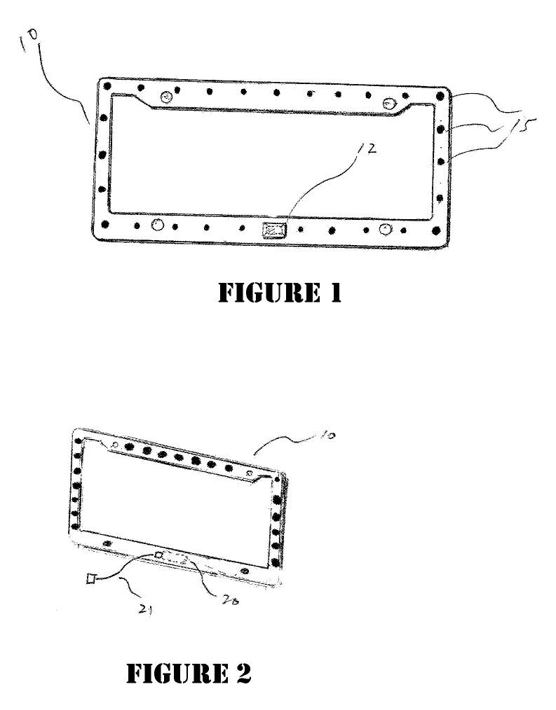

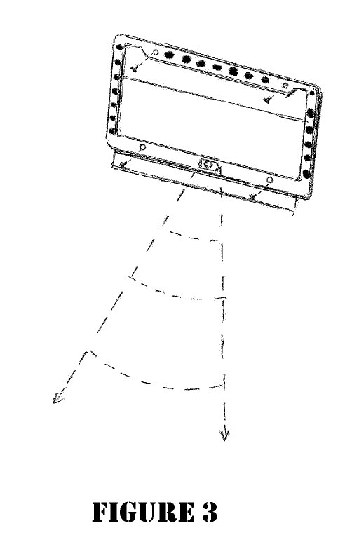

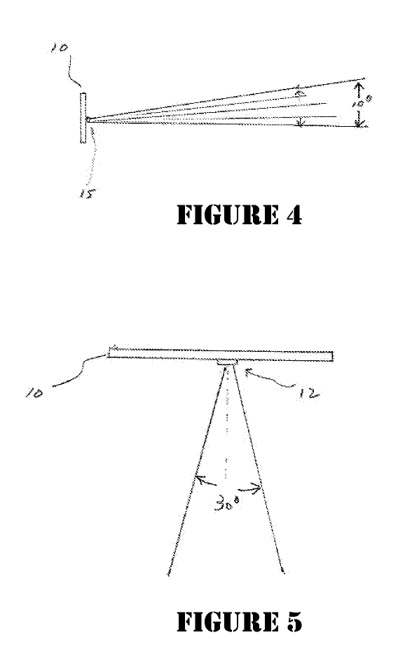

### DETAILED DESCRIPTION OF THE PREFERRED EMBODIMENT

A license plate holder 10 is made to be in a generally rectangular shape, which is a slightly larger concentric shape of a normal license plate issued by state Department of Motor Vehicles, or similar governing agencies in many jurisdictions.

A generally smaller concentric opening is provided in the center area. A motion sensor 12 is built to the lower center portion of the first side, aka front side, of the holder 10.

Although said motion sensor 12 can be located anywhere on the first side of the holder 10, the lower center position will be the preferred location, providing a balanced sensing/detecting in most situations.

Said motion sensor unit 12 can also be located in the top center position on the first side of said holder 10.

A plurality of high-intensity narrow-focus LED lights 15 are built into the rectangular circumference around the first side of said holder 10. These LED lights 15 are controlled by the motion sensor unit 12 (having internal control circuitry) to sense and detect the motion/approaching by the vehicles from behind the car mounted with the impact-warning plate holder 10 of present invention.

Said motion sensing unit 12 will have an effective sensing range of 20 feet, with adjustable shorter ranges to be set by individual users. That way, when an aft vehicle comes too close within the set range, (the default 20 feet, for example), the control circuitry would activate the LED lights 15 and shine towards the driver of the aft vehicle, resulting in timely warning to the driver in the aft vehicle and reduces the chance of impact from the aft vehicle to the vehicle equipped with the warning device of present application. Should different sensor technology be adopted, the nominal sensing distance will be changed, according to specific implementation. For example, more powerful and longer-range sensing unit 12 that covers 30 feet or longer can be used, as chosen by users.

This warning effect works best in the situation where drivers' sense of speed and distance become dull due to sustained cruising at high speed. With the warning light having been activated, the driver in the aft vehicle will be in a better position to react and apply brake, slow down, than otherwise the case where the dull sense of speed and distance results in longer reaction time and more likely to have an accident.

The sensor unit 12 will have a preferred sensing angle of 30 degrees, in terms of horizontal fanning angle, so that, during drive time, vehicles on the two sides are less likely to trigger the LED being lit up to warn the aft-vehicles. The sensing angle on said sensor unit 12 can be adjusted, so that, depending on user preference, said sensor unit 12's sensing angle may be set to cover wider angles. Although this may have more “false alarm” reporting (especially in cases where the cars behind are coming up from the two lanes on the left and right sides), causing the LED lights 15 go lit up, in crowded driving condition, this does provide more warning to the cars behind.

Said plurality of LED lights 15 will have a preferred vertical (up-down) fanning angle of 10 degrees, so that the shining/warning will be more effective due to the fact that the lights are focused at the vertical range where the aft vehicle's driver's eye levels are normally located.

Vehicles that are more than 150 feet behind the car equipped with warning device of present application will generally perceive no adverse effect, or the sense of warning, due to the 10-degree range setting for the up-down fanning angle. To these drivers, the LEG lights will be a very faint light that is no different from other random lights that occur in normal driving. The angle setting works the best for vehicles coming within the distance between 150 feet to 20 feet.

Depending on specific implementation, the vertical fanning angle may be made to cover more than 10 degrees.

A battery power source 20 will be built to the second side, aka the back side, of said holder 10. The battery power 20 will be generally a 12-volt system that is commercially available on the market. Specific implementations of present invention can vary the voltage and amp-power spec depending on other factors, such as the number of the LED lights used.

Alternatively, a connecter wire bundle 21 will be provided to the second side of said holder 10, so that the motion sensing unit 12 and the LED lights 15 will be powered by the electrical system of the vehicle, via connecting to the tail light and brake control signal wires that are commonly found on many trailer wiring connectors.

To increase the effectiveness of the shining/warning, and for added security in foggy weather, the LED lights 15 can be made up of different colors, such as a thin color covering on the outside. Also, the control circuitry inside said motion sensing unit 12 may be programmed to produce fast-flashing effect, enhancing the visual impact to the driver in the aft vehicle.

For installation and operation of the impact-warning device of present invention, a user will mount the holder 10 over a licensing plate at the rear end of a vehicle.

The user can optionally connect the wire bundle 21 to the trailer wiring connector that comes with the vehicle, or use the battery power 20, to provide power to the motion sensing unit 12, which in turn control when to activate the high-intensity LED lights 15.

Within the set distance range (default of 30 feet) and the fanning angle of 30 degrees, if an aft vehicle is detected, the LEDT lights 15 will shine towards the driver in the aft vehicle, thus producing the warning signal to the driver, alerting him/her that the he/she should slow down the vehicle, keep a safe distance, to avoid hitting the read end of front vehicle.

The available technology in the motion-sensing unit 12 bears no disclosure herein. The power consumption of the motion-sensing unit 12 is minimal and thus would not drain a lot of the battery power 20, during normal usage pattern. The LED lights 15 are similarly a type of components that use very little amount of power, at time of activation by the motion-sensing unit 12. Thus there is practical application of a battery-powered warning device of present invention in the case of a battery power source 20.

When the optional connector bundle 21 is used, there is unlimited power to the device described herein.

What is claimed is:

1. An impact-warning and prevention device, comprising:
a. a generally rectangular license plate holder with a central concentrically-shaped opening;
b. a motion sensing unit with built-in control circuitry mounted on the first side of said plate holder;
c. a plurality of high-intensity LED lights mounted around the rectangular circumference around said plate holder; and,
d. a battery power source connecting to said motion sensing unit at the second side of said plate, providing electrical power to the sensing unit and the LED lights.

2. The impact-warning and prevention device of claim 1, wherein said motion sensing unit has an adjustable sensing angle with a preferred preset angle of 30 degrees.

3. The impact-warning and prevention device of claim 1, wherein the plurality of LED lights are set to shine out with an up-down fanning angle 10 degrees, from a normal base angle set to horizontal alignment.

4. The impact-warning and prevention device of claim 1, wherein the plurality of LED lights are set to cover an up-down fanning angle of more than 10 degrees, depending upon user implementation.

5. The impact-warning and prevention device of claim 1, further comprising an optional power connecting cable for hooking up to the tail light and brake signal/control wires provided on the rear end of a vehicle.

6. The impact-warning and prevention device of claim 1, wherein the LED lights are made with different color covers and with fast-changing flashing circuit control, to increase the warning effect.
